(19) United States
(12) Patent Application Publication
(10) Pub. No.: US 2007/0161447 A1
(43) Pub. Date: Jul. 12, 2007

(54) Belt for continuously variable transmission (CVT) and CVT including the same

(76) Inventors: Yong Uk Shin, Hwaseong-city (KR); Sung Ho Shin, Suwon-city (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/507,750

(22) Filed: Aug. 22, 2006

(30) Foreign Application Priority Data
Jan. 12, 2006 (KR) 10-2006-0003673

(51) Int. Cl. F16G 5/16; F16G 1/00; F16G 1/21

(52) U.S. Cl. 474/242; 474/201

(57) ABSTRACT

A belt for a continuously variable transmission, and a continuously variable transmission including the same, includes a plurality of clips, each defining a space which defines a groove to which a ring is inserted, thereby reducing slip.

### CROSS-REFERENCE TO RELATED APPLICATION

This application claims priority to and the benefit of Korean Patent Application No. 10-2006-0003673 filed in the Korean Intellectual Property Office on Jan. 12, 2006, the entire contents of which are incorporated herein by reference.

### BACKGROUND OF THE INVENTION

1. Field of the Invention

The present invention relates to a belt for a continuously variable transmission (CVT) and a CVT including the same. More particularly, the present invention relates to a belt for a CVT and a CVT including the same that reduces slip between rings of the belt and clips.

2. Description of the Related Art

Generally, a continuously variable transmission (CVT) includes a primary pulley connected to a drive shaft and a secondary pulley connected to a driven shaft. Power is transmitted from the primary pulley to the secondary pulley by a belt, which includes clips and a ring inserted to the clips. Radii of the drive shaft and the driven shaft are variable, so that the power transmitted from the primary to the secondary pulley is variable.

Because the radii of the ring contacting the primary pulley and the secondary pulley are larger than radii formed by the clips, slip occurs between the ring and the clips at the side with the smaller contact radius. That is, because the radii of the drive shaft and the driven shaft are variable, if a shift speed ratio is large, slip occurs at the side of the drive shaft because the contact radius of the drive shaft is smaller, and if a shift speed ratio is small the slip occurs at the side of the driven shaft because the contact radius of the driven shaft is smaller. As shown by experiments, the biggest slip occurs in the driven shaft in overdrive.

The above information disclosed in this Background section is only for enhancement of understanding of the background of the invention and therefore it may contain information that does not form the prior art that is already known in this country to a person of ordinary skill in the art.

### SUMMARY OF THE INVENTION

An exemplary CVT including a belt for variably transmitting power according to an embodiment of the present invention includes a primary pulley to which the power is input, a secondary pulley for receiving the power from the primary pulley, and a belt for transmitting the power from the primary pulley to the secondary pulley, wherein the belt includes at least one ring and a plurality of clips each defining a space in which the ring is disposed. Each space may define a groove to which the ring is inserted. The number of grooves on each clip may be equal to the number of rings. Each groove may have a depth of 1 mm.

An exemplary belt for transmitting power from a primary pulley to a secondary pulley of a CVT according to an embodiment of the present invention includes at least one ring and a plurality of clips, each defining a space in which the ring is disposed. Each space may define a groove to which the ring is inserted. The number of grooves on each clip may be equal to the number of rings. Each groove may have a depth of 1 mm.

### BRIEF DESCRIPTION OF THE DRAWINGS

FIG. 1 shows a continuously variable transmission (CVT) according to an exemplary embodiment of the present invention; and

FIG. 2 is a cross-sectional view showing a belt of the CVT according to an exemplary embodiment of the present invention.

### DETAILED DESCRIPTION OF THE PREFERRED EMBODIMENTS

An exemplary embodiment of the present invention will hereinafter be described in detail with reference to the accompanying drawings.

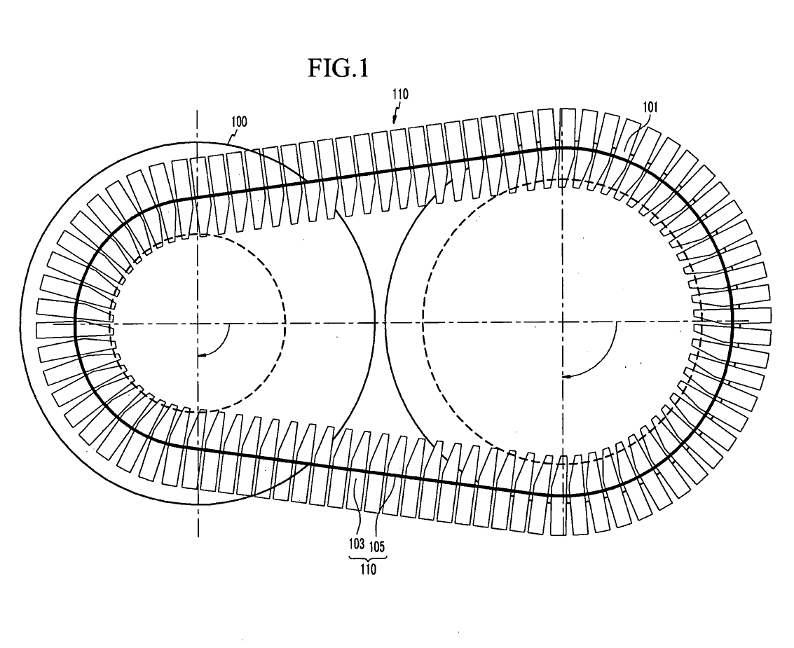

As shown in FIG. 1, according to an exemplary embodiment of the present invention, a continuously variable transmission CVT includes a primary pulley 100, a secondary pulley 101, and a belt 110. Power is input to the primary pulley 100, and is transmitted by the belt 110 from the primary pulley 100 to the secondary pulley 101.

The primary pulley 100 is connected to a conical drive shaft (not shown) and the secondary pulley 101 is connected to a conical driven shaft (not shown). Because the drive shaft and driven shaft move axially, radii of the belt 110 around the drive shaft and the driven shaft are variable.

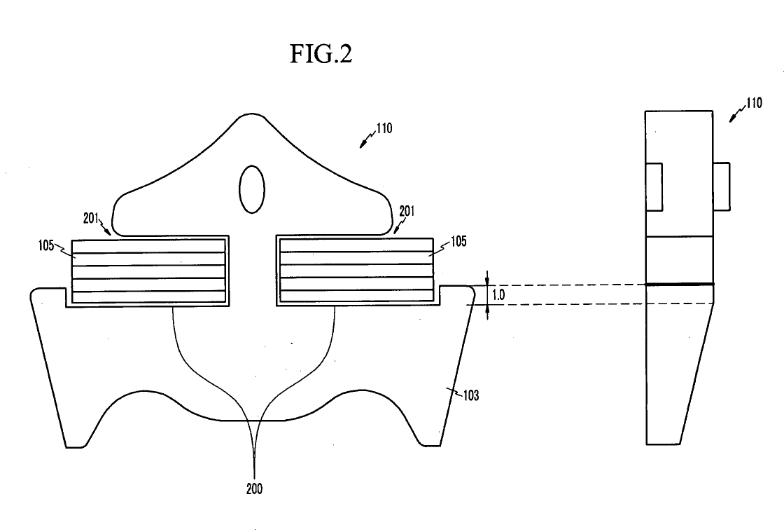

Referring also to FIG. 2, the belt 110 includes at least one ring 105 and a plurality of clips 103. At least one space 201 at which the ring 105 is located is provided on each of the clips 103, and each space 201 may include a groove 200 to which the ring 105 is inserted.

The depth of the grooves 200 may be selected based on the shapes and sizes of the ring 105 and the clips 103, and on an angle between the clips 103. The depth should be selected such that frictional resistance between the ring 105 and the clips 103 is minimized. In an exemplary embodiment, the depth of the grooves 200 is 1 mm.

Referring still to FIG. 2, some embodiments provide two rings 105, two spaces 201 on each clip 103, and a groove 200 in each space 201.

Because the grooves 200 are formed in the spaces 201 to which each ring 105 is disposed, slip between the clip 103 and the rings 105 can be reduced. Therefore, power delivery efficiency between the primary pulley 100 and the secondary pulley 101 and durability of the continuously variable transmission can be enhanced.

According to embodiments of the present invention, because slip of the belt is reduced, the power delivery efficiency can be enhanced and the durability of the continuously variable transmission can be enhanced.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A continuously variable transmission (CVT) for variably transmitting power, comprising:
a primary pulley to which the power is input;
a secondary pulley for receiving the power from the primary pulley; and
a belt for transmitting the power from the primary pulley to the secondary pulley, wherein the belt comprises:
a first ring; and
a plurality of clips, each defining a first space in which the first ring is disposed, wherein at least one of said first spaces defines a groove to which the first ring is inserted.

2. The CVT of claim 1, wherein each of said first spaces defines a groove.

3. The CVT of claim 1, further comprising a second ring, wherein each clip further comprises a second space in which the second ring is disposed.

4. The CVT of claim 3, wherein each of said first and second spaces defines a groove.

5. The CVT of claim 1, wherein a depth of the groove is approximately 1 mm.

6. A belt for transmitting a power from a primary pulley to a secondary pulley of a continuously variable transmission (CVT), comprising:
a first ring; and
a plurality of clips, each defining a first space to which the first ring is disposed, wherein at least one of said first spaces defines a groove to which the first ring is inserted.

7. The belt of claim 6, wherein each of said first spaces defines a groove.

8. The belt of claim 6, further comprising a second ring, wherein each clip further comprises a second space in which the second ring is disposed.

9. The belt of claim 8, wherein each of said first and second spaces defines a groove.

10. The belt of claim 6, wherein a depth of the groove is approximately 1 mm.
